(19) United States
(12) Patent Application Publication
(10) Pub. No.: US 2016/0214425 A1
(43) Pub. Date: Jul. 28, 2016

(54) Writing Template

(71) Applicant: Mabel Ko, Vancouver (CA)

(72) Inventor: Mabel Ko, Vancouver (CA)

(21) Appl. No.: 14/602,451

(22) Filed: Jan. 22, 2015

(51) Int. Cl. B43L 13/20

(52) U.S. Cl. CPC B43L 13/20

(57) ABSTRACT

The present invention is an article for assisting with writing on a surface having a main body with a plurality of writing surface access cavities formed in said main body and at least one securing tab being foldable edge portion constructed and arranged to simultaneously position and secure a writing surface.

### BACKGROUND OF THE INVENTION

The handwriting endeavors of many people are still utilized to a great extent. A difficulty arises when persons have writing surfaces which do not have guidelines or score lines to guide the handwriting process. Sometimes it is desirable to have uniform writing without having any guidelines or score lines. The present invention provides an article with a plurality of cavities that permits a user to use a writing instrument, write on the writing surface, and remove the writing surface, thus producing relatively uniform written lines.

### SUMMARY OF THE INVENTION

In one embodiment, the present invention is a writing guide/template made of clear/colored acrylic or similar material with a controlled lip, or foldable edge on the top and side that keeps the paper in place while writing. It is contemplated to help a person write straight horizontally or vertically on unlined paper, greeting cards, projects or books/journals, letterheads without having to draw lines or use a ruler. The lip folds under the paper to allow control of the paper while writing. If the paper was accidentally moved, the lip is the guide to help reposition the paper to its originally place for smooth continuous writing. It is contemplated further that it will be configured in different sizes, approx 8½×11, and half the size, as well as any other customizable size as needed.

In one embodiment, the template is between about 0.5 to 4.0 mm thick. A preferred embodiment includes the template between about 1-2 mm thick.

In one embodiment, the present invention is formed of a rigid or semi-rigid material including, but not limited to plastics, polymers, composites, combinations thereof, and the like.

In one embodiment, the present invention is an article for assisting with writing on a surface, said article comprising: a main body having opposing surfaces being an upper and lower surface; a plurality of writing surface access cavities defined by a boundary and formed in said main body, whereby said main body is constructed and arranged to secure a writing surface associated therewith; at least one securing tab being foldable edge portion constructed and arranged to simultaneously position and secure a writing surface.

In one embodiment, the main body is clear, transparent, translucent, or combinations thereof.

In one embodiment, the access cavity boundary is rigid.

In one embodiment, the main body includes one pair of foldable edge portions.

In one embodiment, the main body includes two pair of foldable edge portions.

Also contemplated is a method of writing on a surface, said method comprising:
providing an article according to the invention described herein;
providing a writing surface;
securing said writing surface into a fixed and defined position by said securing tab;
providing a writing utensil;
writing on said writing surface with said writing utensil through at least one access cavity.

### BRIEF DESCRIPTION OF THE SEVERAL VIEWS OF THE DRAWING

FIG. 1 is a perspective view demonstrating the system of the present invention in use.

FIG. 2 is a planned view according to one embodiment of the present invention.

FIG. 3 is a side view according to one embodiment of the present invention.

FIG. 4 is a partial perspective view demonstrating insertion of paper into a holder according to the present invention.

FIG. 5 is a partial perspective view demonstrating the corner holder of the present invention.

FIG. 6 is a partial perspective view demonstrating placement of paper into an embodiment of the present invention.

FIG. 7 is a partial perspective view demonstrating paper inserted into a holder according to one embodiment of the present invention.

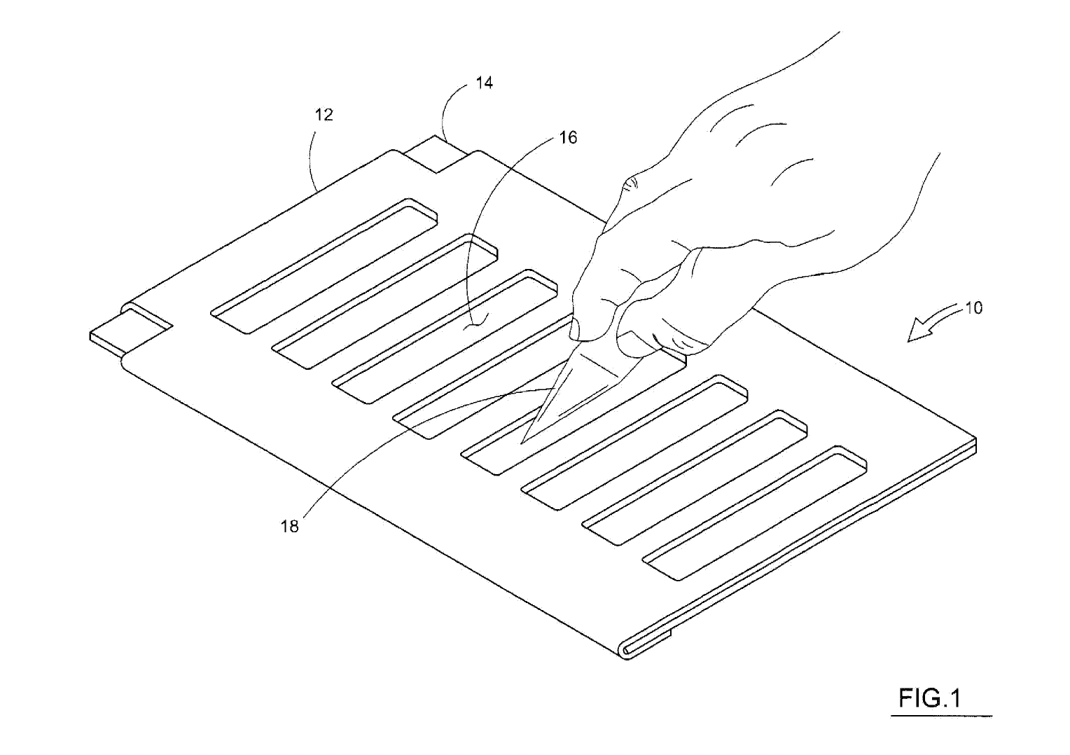

### DETAILED DESCRIPTION OF THE PREFERRED EMBODIMENT

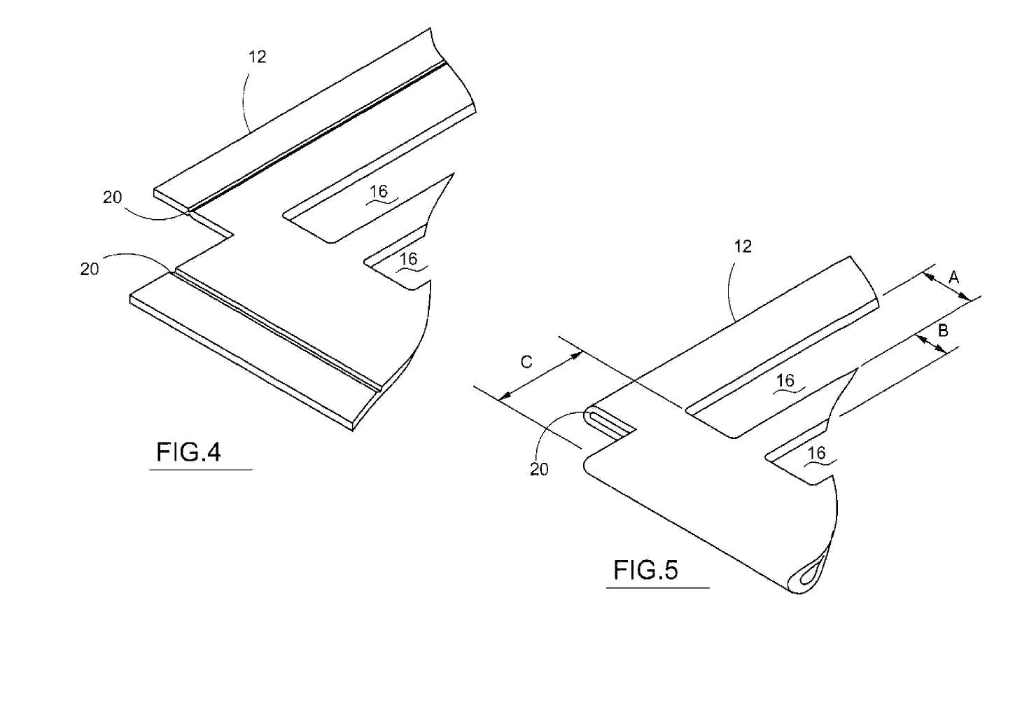

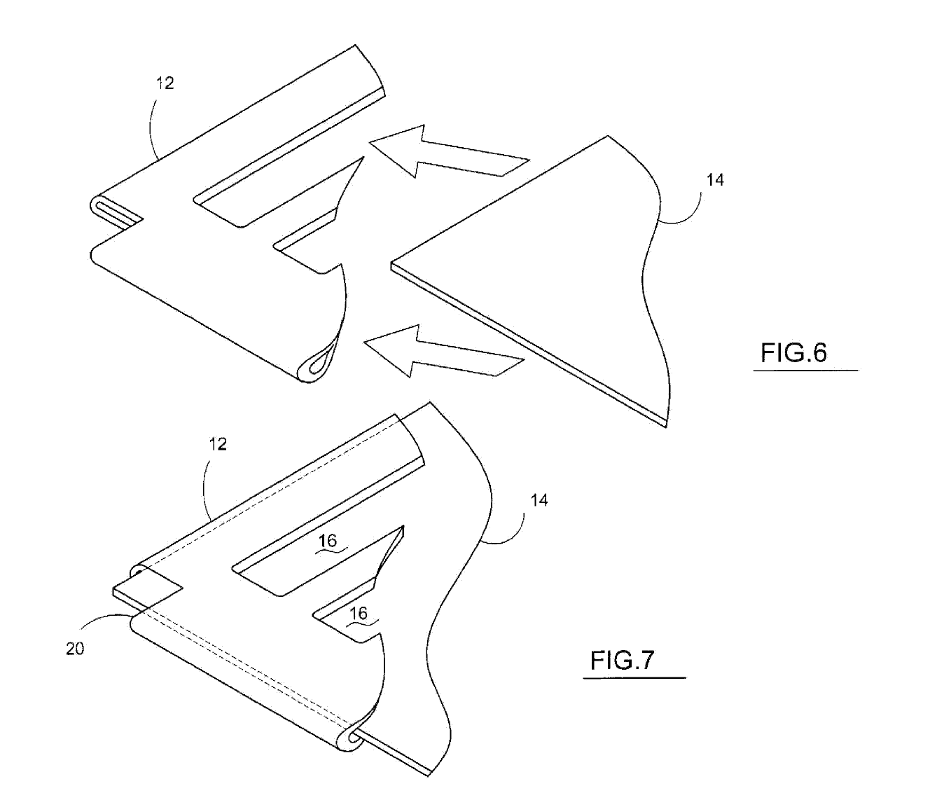

As generally understood, the present invention provides an apparatus for assisting handwriting on a surface. Guide 10 has a main body 12. Main body 12 is constructed and arranged to be used with a writing surface 14. Although writing surface 14 generally is understood to mean paper and paper-like products, it is not limited to such, and writing surface can include any surface that is utilized with the system of the present invention. Main body 12 has formed therein a plurality of surface access cavities 16 in which writing implement 18 uses to access writing surface 14. In one embodiment, as demonstrated in FIGS. 4 and 5, main body 12 has one or more living hinges 20 that are used in a closed position to secure writing surface 14 into position relative to main body 12.

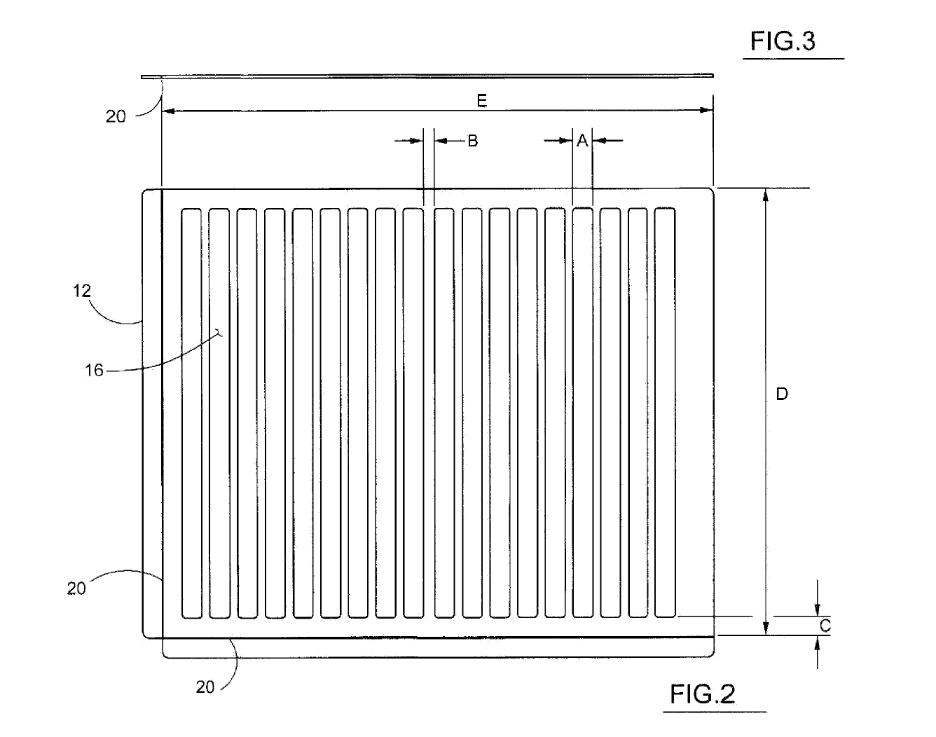

As demonstrated in FIG. 2, main body 12 is configured with dimension A being the width of access opening 16. Dimension B representing the distance between each access opening 16. Dimension C representing the margin spacing imparted by main body 12 on writing surface 14. Dimension D indicating the width of writing surface 14 utilized with main body 12. Dimension E representing the height of writing surface 14 utilized with main body 12.

As generally understood, a user will take a writing surface 14 and position it securely within main body 12. The user then will take writing instrument 18 and use each of cavities 16 to perform writing operations. In utilizing each individual cavity 16 in this manner, a user is able to uniformly write on writing surface 14 without having to produce any guidelines or score lines on writing surface 14. When a user has completed their desired writing, writing surface 14 is removed from its secured position relative to main body 12. In one embodiment, as discussed above, living hinge 20 provides a fold as demonstrated in FIGS. 4 and 5, such that writing surface 12 is grasped and secured into position. As will be generally understood and appreciated, it is desirable that writing surface 14 not move relative to main body 12 until the writing operation is completed. In this manner, each of the desired markings that are placed on writing surface 14 utilizing each cavity 16 remain relatively uniform.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. An article for assisting with writing on a surface, said article comprising: a main body having opposing surfaces being an upper and lower surface; a plurality of writing surface access cavities defined by a boundary and formed in said main body, whereby said main body is constructed and arranged to secure a writing surface associated therewith; at least one securing tab being foldable edge portion constructed and arranged to simultaneously position and secure a writing surface.

2. The article of claim 1 wherein said main body is clear, transparent, translucent, or combinations thereof.

3. The article of claim 1 wherein said access cavity boundary is rigid.

4. The article of claim 1 wherein said main body includes one pair of foldable edge portions.

5. The article of claim 1 wherein said main body includes two pair of foldable edge portions.

6. A method of writing on a surface, said method comprising:
providing an article according to claim 1;
providing a writing surface;
securing said writing surface into a fixed and defined position by said securing tab;
providing a writing utensil;
writing on said writing surface with said writing utensil through at least one access cavity.
